(19) United States
(12) Patent Application Publication
(10) Pub. No.: US 2009/0222456 A1
(43) Pub. Date: Sep. 3, 2009

(54) APPARATUS FOR STORING AND PROCESSING CONTENTS AND METHOD OF TRANSMITTING OBJECT META INFORMATION ON CONTENTS USING MEDIA TRANSFER PROTOCOL FROM THE APPARATUS

(75) Inventor: Seong-min KANG, Hwaseong-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/243,212

(22) Filed: Oct. 1, 2008

(30) Foreign Application Priority Data
Mar. 3, 2008 (KR) 2008-19640

(51) Int. Cl. G06F 17/30

(52) U.S. Cl. 707/10; 707/E17.032

(57) ABSTRACT

An apparatus for storing and processing contents and a method of transmitting object meta information on contents by using a media transfer protocol (MTP) in the apparatus includes selections for transmission a limited number of pieces of the object meta information according to a display status of a content reproduction apparatus receiving the transmission. Accordingly, since only a limited number of pieces of object meta information are selected according to a display status of the content reproduction apparatus, and only the selected pieces of object meta information are transmitted to the content reproduction apparatus, it is possible to minimize the MTP operation for transmitting the object meta information and to minimize transmission of data. As a result, an inconvenience to a user due to a latency time of an operation is reduced by reducing a delay time in a connection between devices.

### CROSS-REFERENCE TO RELATED APPLICATION

This application claims the benefit of Korean Patent Application No. 2008-19640, filed Mar. 3, 2008 in the Korean Intellectual Property Office, the disclosure of which is incorporated herein by reference.

### BACKGROUND OF THE INVENTION

1. Field of the Invention

Aspects of the present invention relate to transmission of data, and more particularly, to a method of transmitting object meta information on contents by using a media transfer protocol (MTP) and an apparatus for performing the same.

2. Description of the Related Art

As the demands for copyright protection have increased, the copyright protection of digital media files has become an important issue as paid digital contents tend to be increasingly distributed and used. Copyright protection of digital media files mainly relates to WINDOWS media digital right management (WMDRM) and media transfer protocol (MTP). WMDRM is a technique for protecting the rights of a copyright holder by preventing digital contents (such as music, movies, etc.) from being illegally used in a WINDOWS media environment (such as the Windows multimedia player (WMP)). Using this technique, a media file purchased from a contents provider can be used on a user's portable device, in addition to a personal computer (PC). In one estimate, WMDRM is used by about half of all U.S. music sites.

MTP is a transmission protocol for transmitting and/or sharing contents of a user that are stored on a PC or the user's portable device and are subjected to WMDRM. MTP operates in conjunction with the WINDOWS media player and a file explorer and enables media files stored in an apparatus for storing and processing data to be read and controlled via the PC. In the current MTP, an apparatus for storing and processing data that is connected to a PC concurrently requests object meta information on all the media files (contents) stored in the apparatus when using the WMP and a file explorer on the PC. Accordingly, an amount of information transmitted between the PC and the apparatus varies according to an amount of meta information and the number of files stored in the apparatus. In case of a mass storage device that stores a large number of media files, an amount of object meta information to be transmitted when connecting the PC with the mass storage device increases. This causes a delay in a connection between the PC and the apparatus for storing and processing contents, thereby causing an inconvenience to a user.

### SUMMARY OF THE INVENTION

Aspects of the present invention provide a method of transmitting object meta information capable of preventing an unnecessary delay by minimizing an amount of data transmitted when initially connecting a PC with an apparatus for storing and processing contents, and an apparatus for storing and processing contents and executing the method.

Aspects of the present invention provide a computer-readable recording medium having embodied thereon a computer program for executing the method of transmitting object meta information.

According to an aspect of the present invention, there is provided a method of transmitting object meta information on contents from an apparatus for storing and processing the contents to a content reproduction apparatus through a media transfer protocol (MTP), the method including: receiving from the content reproduction apparatus information on a folder including contents corresponding to the object meta information to be transmitted; selecting a limited number of pieces of object meta information from among all pieces of object meta information on the contents included in the folder according to a display status of the content reproduction apparatus; storing information on a position of a last selected piece of object meta information among the selected pieces of object meta information in a first storage unit; and transmitting the selected pieces of object meta information to the content reproduction apparatus.

According to an aspect of the present invention, the selecting of the limited number of pieces of object meta information may include: selecting the limited number of pieces of object meta information counting from object meta information on a first content among contents included in the folder when initially transmitting object meta information on the folder; and selecting the limited number of pieces of object meta information counting from object meta information on next contents to contents corresponding to previously transmitted object meta information by using the information on the position of the last selected piece of object meta information stored in the first storage unit when additionally transmitting object meta information on the folder.

According to an aspect of the present invention, the receiving of the information on the folder may include receiving information on the display status of the content reproduction apparatus with the information on the folder from the content reproduction apparatus.

According to an aspect of the present invention, the selecting of the limited number of pieces of object meta information may include: storing the received information on the display status of the content reproduction apparatus in a second storage unit; and selecting the limited number of pieces of object meta information by using the information on the display status stored in the second storage unit.

According to an aspect of the present invention, the method of transmitting object meta information may further include: receiving, from the content reproduction apparatus, information indicating that the display status of the content reproduction apparatus is changed; and storing the information on the changed display status in the second storage unit.

According to an aspect of the present invention, the selecting of the limited number of pieces of object meta information may include: selecting a limited number of object handles corresponding to the contents included in the folder according to the display status; and extracting the limited number of pieces of object meta information according to the display status by using the selected object handles.

According to an aspect of the present invention, the storing of the information on the position of the last piece of object meta information may include storing a position in which an object handle that is finally selected from among the selected object handles is stored in the first storage unit, wherein the selecting of the limited number of object handles may include selecting the limited number of object handles counting from a next position to the position of the object handle that is finally selected stored in the first storage unit.

According to an aspect of the present invention, the information on the display status of the content reproduction apparatus may indicate a number of pieces of object meta information that can be concurrently displayed by the content reproduction apparatus.

According to an aspect of the present invention, the method of transmitting object meta information may further include: receiving from the content reproduction apparatus a sorting standard of pieces of object meta information to be transmitted; extracting the pieces of object meta information on all the contents included in the folder; and sorting the extracted pieces of object meta information according to the sorting standard, wherein the selecting of the limited number of pieces of object meta information may include selecting the limited number of pieces of object meta information from among the sorted pieces of object meta information.

According to an aspect of the present invention, the object meta information may include information on copyrights of respective contents corresponding to the object meta information.

According to an aspect of the present invention, the selecting of the limited number of pieces of object meta information may include: receiving from the content reproduction apparatus a message for requesting a first number of pieces of object meta information; extracting object handles corresponding to the first number of pieces of object meta information from among the pieces of object meta information on the contents included in the folder; and selecting the first number of pieces of object meta information from among the pieces of object meta information on the contents included in the folder using the extracted object handles, wherein the storing of the information on the position of the last piece of object meta information may include storing in the first storage unit a position where an object handle corresponding to the last piece of object meta information of the extracted object handles is stored.

According to another aspect of the present invention, there is provided an apparatus for storing and processing contents, which transmits object meta information on contents to a content reproduction apparatus through a media transfer protocol (MTP), the apparatus including: a folder information receiving unit to receive from the content reproduction apparatus information on a folder including the contents corresponding to the object meta information to be transmitted; an object meta information selection unit to select a limited number of pieces of object meta information from among all pieces of object meta information on the contents included in the folder according to a display status of the content reproduction apparatus; a first storage unit to store information on a position of a last selected piece of object meta information among the selected pieces of object meta information; and an object meta information transmission unit to transmit the selected pieces of object meta information to the content reproduction apparatus.

According to an aspect of the present invention, the object meta information selection unit may select the limited number of pieces of object meta information counting from object meta information on a first content among contents included in the folder when initially transmitting object meta information with respect to the folder, and the object meta information selection unit may select the limited number of pieces of object meta information counting from object meta information on next contents to contents corresponding to previously transmitted object meta information using the stored information on the position of the last selected piece of object meta information stored in the first storage unit when additionally transmitting object meta information on the folder.

According to an aspect of the present invention, the apparatus for storing and processing contents may further include a second storage unit to store information on the display status of the content reproduction apparatus, wherein the folder information receiving unit may receive from the content reproduction apparatus the information on the display status of the content reproduction apparatus with the information on the folder and may store the received information in the second storage unit, and the object meta information selection unit may select the limited number of pieces of object meta information using the information on the display status stored in the second storage unit.

According to an aspect of the present invention, the object meta information selection unit may include: an object handle selection unit to select a limited number of object handles corresponding to the contents included in the folder according to the display status; and an object meta information extraction unit to extract the limited number of pieces of object meta information according to the display status using the selected object handles.

According to an aspect of the present invention, the object handle selection unit may store in the first storage unit a position where an object handle that is finally selected from among the selected object handles is stored, and may select the limited number of object handles counting from a next position to the position of the object handle that is finally selected stored in the first storage unit.

According to an aspect of the present invention, the information on the display status of the content reproduction apparatus may indicate a number of pieces of object meta information that can be concurrently displayed by the content reproduction apparatus.

According to an aspect of the present invention, the apparatus for storing and processing contents may further include: a sorting standard receiving unit to receive from the content reproduction apparatus a sorting standard of the pieces of object meta information to be transmitted; an object meta information table to extract and to store the pieces of object meta information on all of the contents included in the folder; and an object meta information sorting unit to sort the extracted pieces of object meta information stored in the object meta information table according to the sorting standard, wherein the object meta information selection unit may select the limited number of pieces of object meta information from among the sorted pieces of object meta information.

According to an aspect of the present invention, the object meta information may include information on copyrights of respective contents corresponding to the object meta information.

According to an aspect of the present invention, when receiving a message for requesting a first number of pieces of object meta information from the content reproduction apparatus, the object meta information selection unit may extract object handles corresponding to the first number of pieces of object meta information from among the pieces of object meta information on the contents included in the folder, may select the first number of pieces of object meta information from among the pieces of object meta information on the contents included in the folder using the extracted object handles and may store in the first storage unit a position where an object handle corresponding to a last piece of object meta information of the extracted object handles is stored.

According to another aspect of the present invention, there is provided a method of transmitting object meta information on contents from an apparatus for storing and processing the contents to a content reproduction apparatus through a media transfer protocol (MTP), the method including: selecting a limited number of pieces of the object meta information from among all pieces of the object meta information on contents included in a predetermined folder according to a display status of the content reproduction apparatus; and transmitting the selected pieces of object meta information to the content reproduction apparatus.

According to another aspect of the present invention, there is provided a system to transmit object meta information on contents through a media transfer protocol (MTP), the system including: an apparatus to store and process the contents including: an object meta information selection unit to select a limited number of pieces of object meta information from among all pieces of object meta information on the contents included in a predetermined folder according to a received display status, and an object meta information transmission unit to transmit the selected pieces of object meta information; and a content reproduction apparatus including: a receiving unit to receive the limited number of pieces of object meta information, a display unit to display the received pieces of object meta information, and a transmission unit to transmit the display status of the display unit to the apparatus to store and process the contents.

According to another aspect of the present invention, there is provided a content reproduction apparatus to receive object meta information on contents through a media transfer protocol (MTP), the apparatus including: a receiving unit to receive a limited number of pieces of object meta information from an apparatus to store and process the contents that determines the limited number of pieces of object meta information according to a display status; and a display unit to display the received pieces of object meta information.

According to another aspect of the present invention, there is provided a method of receiving, at a content reproduction apparatus from an apparatus for storing and processing contents, object meta information on contents through a media transfer protocol (MTP), the method including: receiving a limited number of pieces of object meta information from the apparatus to store and process the contents that determines the limited number of pieces of object meta information according to a display status of the content reproduction apparatus; and displaying the received pieces of object meta information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a media transfer protocol (MTP) operation;

FIG. 2 illustrates a connection process between a personal computer (PC) and an MTP device;

FIG. 3 illustrates a case where all object meta information included in a folder is transmitted by using the MTP;

FIG. 4 illustrates a case where a limited number of pieces of object meta information are transmitted according to an embodiment of the present invention;

FIG. 5 illustrates data codes of the MTP operation according to an aspect of the present invention;

FIG. 6 is a block diagram illustrating a structure of an apparatus for storing and processing contents according to an embodiment of the present invention;

FIG. 7 is a flowchart illustrating a method of transmitting object meta information according to an embodiment of the present invention;

FIG. 8 is a block diagram illustrating a structure of an apparatus for storing and processing contents according to another embodiment of the present invention;

FIG. 9 is a conceptual view illustrating a case where contents are stored in a folder in an apparatus for storing and processing contents;

FIG. 10 illustrates a case where object meta information on contents is stored in an apparatus for storing and processing contents through object meta handles;

FIG. 11 illustrates a procedure of selecting object meta information according to an embodiment of the present invention; and

FIG. 12 illustrates a procedure of selecting object meta information according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

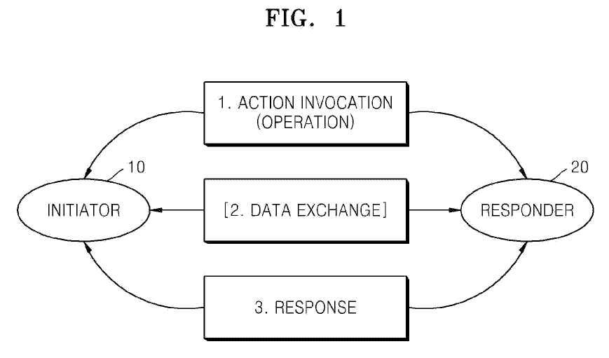

FIG. 1 illustrates a media transfer protocol (MTP) operation. MTP is a protocol for separately transmitting contents and meta information of the contents when transmitting a media file between a personal computer (PC) and a device through a universal serial bus (USB), or a wired and/or wireless Internet protocol (IP) connection. MTP is based on a picture transport protocol (PTP) that includes a transmission layer of a USB/IP, a protocol layer of the PTP, and a command layer in which an MTP operation is practically embodied. While described as a personal computer, it is understood that the media file could also be stored on a personal or home media center. Further, the device receiving the media file can be a portable media player, a phone, another home media center, and/or another pc. Referring to FIG. 1, an MTP operation includes a process of requesting a command from an MTP host 10 (1), a process of transmitting data (2), and a responding process of an MTP device 20. It is understood that the process of transmitting data (2) may be omitted according to other aspects of the present invention.

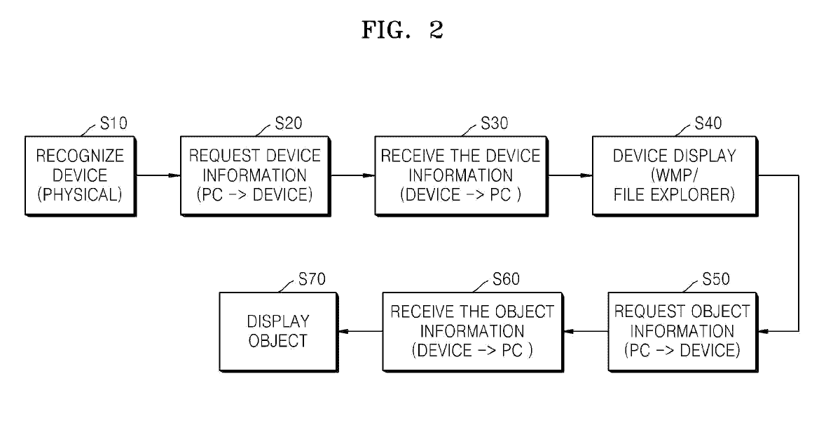

FIG. 2 illustrates a connection process between a personal computer (PC) and an MTP device. The MTP device is connected to the PC through WINDOWS media player (WMP) and/or file explorer. When a physical connection between the MTP device and the PC through the USB or IP is recognized in operation S10, the PC requests device information in operation S20 and receives the device information from the MTP device in operation S30. The PC acquires the device information and displays the device information on the WMP and/or the file explorer in operation S40. Then, a media file stored in the MTP device is displayed in operation S70 according to a control of a user. That is, meta information on all the objects stored in the MTP device is requested in operation S50 and received in operation S60. While described in terms of a physical connection, it is understood that the connection can also be a wireless connection.

The MTP operation for acquiring information (operation S50) on the objects stored in the MTP device may include GetObjectPropDesc( ), GetObjectPropValue( ), GetObjectPropList( ), etc. When the PC requests the aforementioned operations to be performed with respect to a specific object (operation S50), the MTP device returns values on properties of corresponding objects (operation S60). At this time, since the operation is repeatedly performed for each object and attribute of the object, if the number of objects stored in the MTP device increases, the number of times the operations are executed will also increase. Accordingly, since all object meta information included in a folder is transmitted in a conventional MTP technique, a delay occurs in a transmission process.

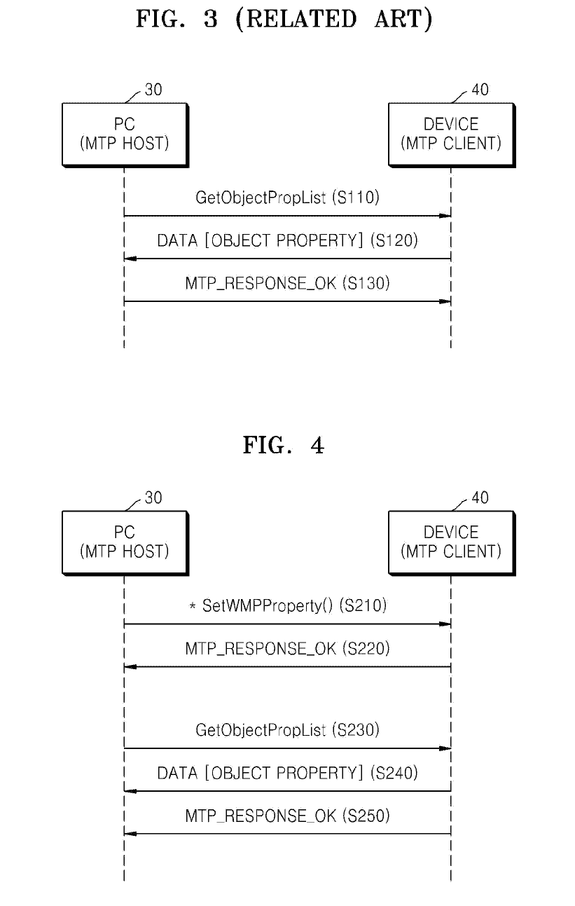

FIG. 3 illustrates a case where all object meta information included in a folder is transmitted by using the MTP. An MTP operation is performed so as to display a list of contents stored in a device 40 to a user when initially connecting a PC 30 to the device 40 or when linking the PC 30 to the device 40 again. The MTP operation has three processes. First, the PC 30 that is an MTP host requests the device 40 that is an MTP client to transmit object meta information in operation S110. The device 40 transmits the object meta information of data (i.e., content) to the PC 30 in operation S120. The PC 30 transmits, to the device 40, a message (MTP_RESPONS_OK) indicating that the object meta information is received in operation S130.

The object meta information may include information on contents and, more specifically, copyright information on contents. The object meta information varies according to a number of attributes of an object and the number of objects stored in the device. In this situation, in a case where a mobile device 40 with a large capacity storage unit that stores a large number of media files is to be connected to the PC 30, the MTP operation is performed with respect to all of the attributes of all of the media files. As a result, a delay occurs in transmitting the object meta information in operation S120. The delay in transmitting the meta information causes a delay in displaying the device information on the WMP and/or the file explorer and a delay in reading contents, thereby causing an inconvenience to a user.

FIG. 4 illustrates a case where a limited number of pieces of object meta information are transmitted according to an embodiment of the present invention. The number of objects displayed on a display device (such as a WMP) is limited. When connecting the PC 30 with the device 40, if only object meta information to be displayed on the WMP is transmitted, it is possible to minimize a delay time in a connection between the PC 30 and the device 40 and reduce a latency time of the user. However, as shown in FIG. 3, all object meta information is transmitted in the conventional MTP technique. On the other hand, in a method of transmitting object meta information according to an embodiment of the present invention, only a limited number of pieces of object meta information is transmitted.

Referring to FIG. 4, information on a status of a display (such as the WMP) is transmitted to the device 40 in operation S210. According to an aspect of the present invention, in operation S210, information on a folder to be displayed (e.g., such as a folder selected by the user) may be transmitted together with the information on the status of the display. However, it is understood that all aspects of the present invention are not limited thereto. For example, according to another aspect, in operation S210, only the information on the status of the display is transmitted, and the information on the folder to be displayed may be transmitted in another operation (such as operation S230).

The device 40 transmits a receipt confirmation message to the PC 30 in operation S220. When the PC 30 requests object meta information from the device 40 in operation S230, the device 40 transmits only a limited number of pieces of object meta information to the PC 30 according to the status of the display in operation S240. The device 40 transmits a receipt confirmation message to the PC 30 in operation S250.

In aspects of the present invention, in order to minimize a delay in an initial connection between the PC 30 and the device 40, only the object meta information to be displayed to the user is firstly received, and objects corresponding to the received object meta information are displayed to the user. Then, in a case where other object meta information is displayed according to a next operation of the user, the other object meta information is additionally requested and received. At this time, only operations S230 to S250 are repeatedly performed.

In operation S210 of FIG. 4, SetWMPProperty( ) is a command for transmitting information on a status of a display. SetWMPProperty( ) is an example of an MTP operation that is additionally embodied so as to transmit information on the status of the display of the WMP or the file explorer to the device 40. It is possible to additionally embody an MTP operation in the data codes of the MTP operation.

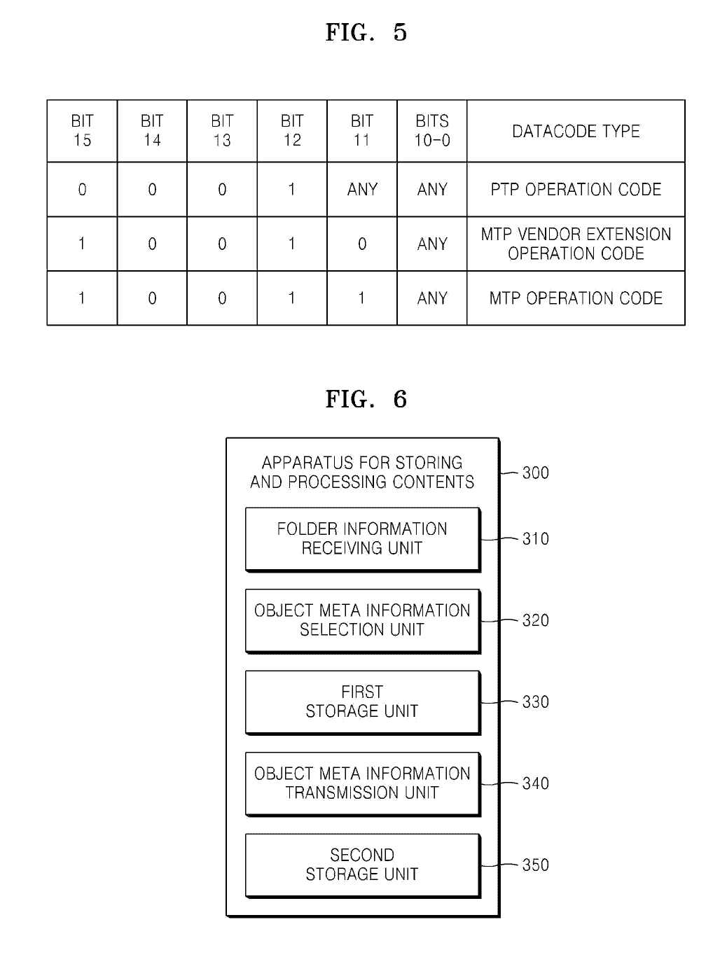

FIG. 5 illustrates data codes of the MTP operation according to an aspect of the invention. As shown in FIG. 5, an MTP specification allows a part to be defined by a vendor in the MTP operation and an MTP object property. That is, it is possible to perform an additional MTP function by additionally defining or embodying the MTP operation and the MTP object property, if necessary. An example of the MTP specification is Media Transfer Protocol, Rev. 1.0 (Dec. 5, 2007), the disclosure of which is incorporated by reference. Accordingly, in an aspect of the present invention, when initially connecting the PC 30 with the device 40, it is possible to newly define and embody the MTP operation (SetWMPProperty( ) of FIG. 4) capable of transmitting information on the display status of the WMP or the file explorer of the PC 30 to the device 40. Since an aspect of the present invention can be implemented through only additional software definition and embodiment without hardware modification, within an allowed range of the existing MTP specification, there is no additional cost by applying aspects of the present invention. However, it is understood that hardware modifications can be used to implement aspects of the invention in addition to or instead of through software.

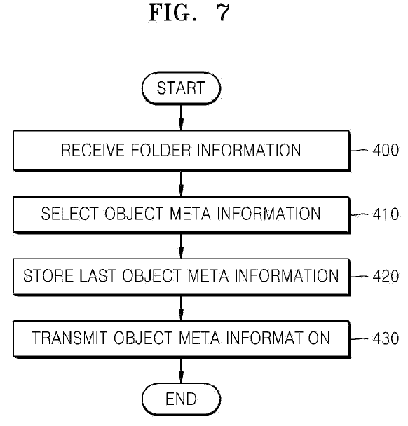

FIG. 6 is a block diagram illustrating a structure of an apparatus 300 for storing and process contents according to an embodiment of the present invention. FIG. 7 is a flowchart illustrating a method of transmitting object meta information according to an embodiment of the present invention. The apparatus 300 for storing and processing contents corresponds to the device 40 of FIG. 4. In an aspect of the present invention, the device 40 is capable of storing and processing the contents. Examples of the apparatus for storing and processing contents according to an embodiment of the present invention are an MP3 player, a computer, a phone, a portable media player (PMP), a personal digital assistant (PDA), etc. Such contents can include audio, video, pictures, software and can be stored internal to the apparatus 300 or on media that is detachable.

Referring to FIGS. 6 and 7, the apparatus 300 for storing and processing contents includes a folder information receiving unit 310, an object meta information selection unit 320, a first storage unit 330, and an object meta information transmission unit 340. However, it is understood that aspects of the present invention are not limited thereto as the apparatus 300 can include additional elements, such as a display or a keyboard, in other aspects of the invention.

The folder information receiving unit 310 receives information on a folder from a content reproduction apparatus in operation 400. Although the content reproduction apparatus corresponds to the PC 30 of FIG. 4, it is understood that the content reproduction apparatus is not limited to the PC. For example, the content reproduction apparatus according to an embodiment of the present invention may be an apparatus for reproducing contents and/or performing an MTP host function, and thus may include media centers, DVRs and other such devices. The information on the folder denotes information on a folder to be displayed on the content reproduction apparatus by the user. That is, the information represents a folder including contents corresponding to the object meta information to be transmitted.

Hereinafter, a folder to be currently displayed by the user is referred to as a folder A. The object meta information selection unit 320 selects a limited number of pieces of object meta information on contents included in the folder A in operation 410. Specifically, the limited number depends on the display status of the content reproduction apparatus. For example, the number may be the number of pieces of object meta information that can be concurrently displayed by the content reproduction apparatus. That is, the limited number depends on the display status of the object meta information in the content reproduction apparatus. For example, if only information on ten contents can be displayed on a display of the content reproduction apparatus, only object meta information on ten contents (for example, first to tenth content) is selected. Thus, when initially transmitting object meta information on the folder A, the object meta information selection unit 320 may select the limited number of pieces of object meta information from object meta information on the first content included in the folder A (for example, from the first to tenth contents). When additionally transmitting object meta information, the object meta information selection unit 320 may then select the next limited number of pieces of object meta information (for example, eleventh to twentieth contents). Accordingly, the object meta information selection unit 320 has to memorize (i.e., save) information on a position of the last piece of transmitted object meta information among the selected pieces of object meta information (in the aforementioned example, information on object meta information corresponding to the tenth content).

The first storage unit 330 stores information on the position of the last piece of object meta information among the selected pieces of object meta information. While not required, the first storage unit 330 can be RAM, but can also be other types of volatile and non-volatile memory (such as ROM, flash memory, or a hard disk drive). As described, it is possible to select a limited number of pieces of object meta information, to transmit the limited number of pieces of object meta information to the content reproduction apparatus, and to store the information on the position (or identifier) of the last transmitted piece of object meta information in the apparatus 300 for storing and processing contents. Accordingly, a transmission amount of data is reduced in the MTP transmission operation.

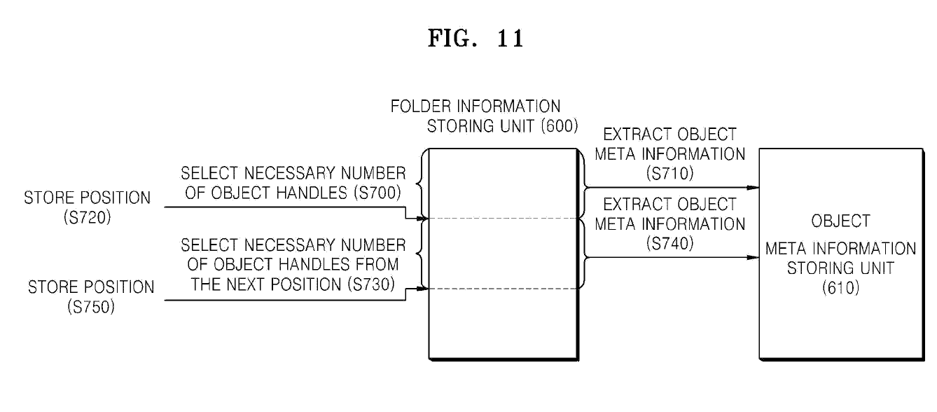

According to an embodiment of the present invention, the object meta information selection unit 320 may include an object handle selection unit (not shown) and an object meta information extraction unit (not shown). The object handle selection unit selects a limited number of object handles corresponding to contents included in a folder according to a display status. The object meta information extraction unit extracts a limited number of pieces of object meta information according to the display status by using the selected object handles. Operations of the object handle selection unit and the object meta information extraction unit will be described in detail with reference to FIG. 11.

The object meta information transmission unit 340 transmits the selected pieces of object meta information to the content reproduction apparatus in operation 430. While not required in all embodiments of the present invention, the apparatus 300 for storing and processing contents further includes a second storage unit 350. The second storage unit 350 stores information on the display status of the content reproduction apparatus. In the embodiment, when receiving information on the display status of the content reproduction apparatus, the folder information receiving unit 310 stores the information on the display status in the second storage unit 350. The object meta information selection unit 320 may select a limited number of pieces of object meta information by using information on the display status stored in the second storage unit 350. In addition, when receiving information that the display status changes from the content reproduction apparatus, the object meta information selection unit 320 stores information on the changed display status in the second storage unit 350 and uses the changed display status in a procedure of selecting object meta information. The second storage unit 350 can be a volatile memory (such as RAM) or a non-volatile memory (such as ROM, flash memory, or a hard disk drive). Also, it is understood that the first storage unit 330 and the second storage unit 350 can be combined into a single storage unit.

According to another embodiment of the present invention, the apparatus 300 for storing and processing contents may not include the second storage unit 350. In this case, the content reproduction apparatus may transmit a message for requesting object meta information that includes information on the display status. Accordingly, the object meta information selection unit 320 extracts information on the display status included in the message for requesting the object meta information and selects a limited number of pieces of object meta information according to the information on the display status.

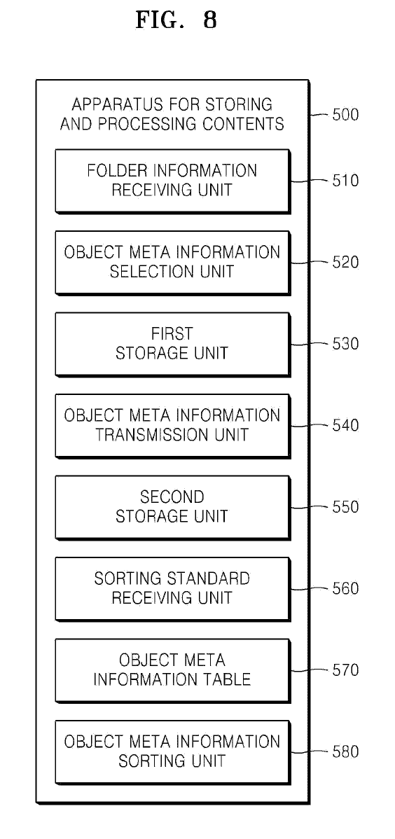

FIG. 8 is a block diagram illustrating a structure of an apparatus 500 for storing and processing contents according to another embodiment of the present invention. Referring to FIG. 8, the apparatus 500 for storing and processing contents includes a folder information receiving unit 510, an object meta information selection unit 520, a first storage unit 530, an object meta information transmission unit 540, a second storage unit 550, a sorting standard receiving unit 560, an object meta information table 570, and an object meta information sorting unit 580.

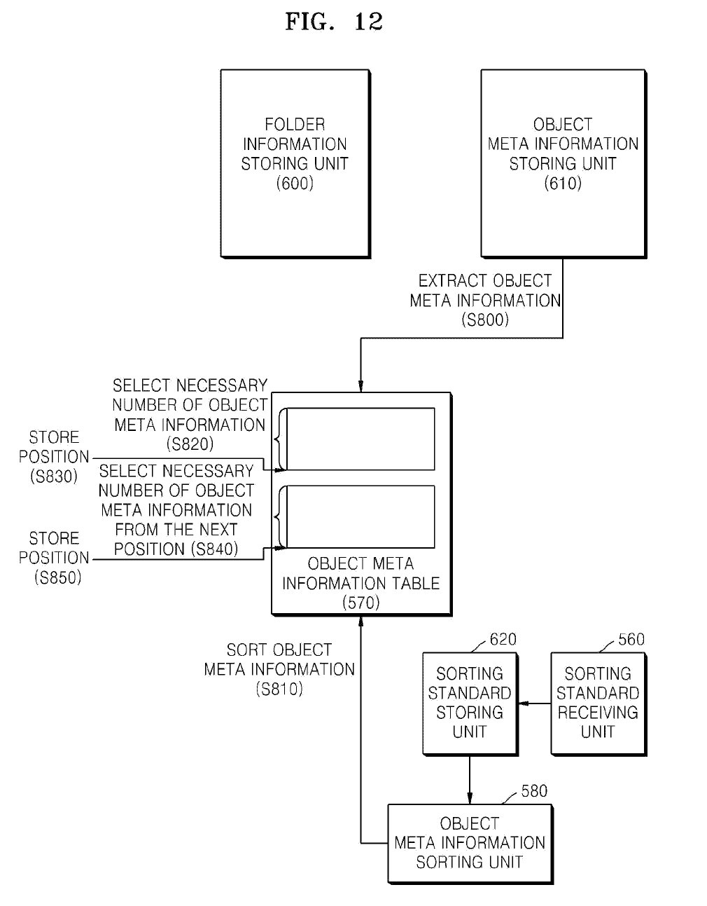

The folder information receiving unit 510 receives information on a folder including contents corresponding to object meta information to be transmitted from the content reproduction apparatus. The object meta information selection unit 520 selects a limited number of pieces of object meta information among pieces of object meta information on contents included in the folder according to the display status of the content reproduction apparatus. The first storage unit 530 stores information on a position (or identifier) of the last transmitted piece of object meta information among the selected pieces of object meta information. The object meta information transmission unit 540 transmits the selected pieces of object meta information to the content reproduction apparatus. The second storage unit 550 stores information on the display status of the content reproduction apparatus. The sorting standard receiving unit 560 receives a sorting standard (hereinafter, referred to as a sorting standard S) of object meta information to be transmitted to the content reproduction apparatus. The object meta information table 570 extracts and stores object meta information on all the contents included in the folder. The object meta information sorting unit 580 sorts the object meta information stored in the object meta information table 570 according to the sorting standard S. Operations of the sorting standard receiving unit 560, the object meta information table 570, the object meta information sorting unit 580, and the object meta information selection unit 520 will be described in detail with reference to FIG. 12.

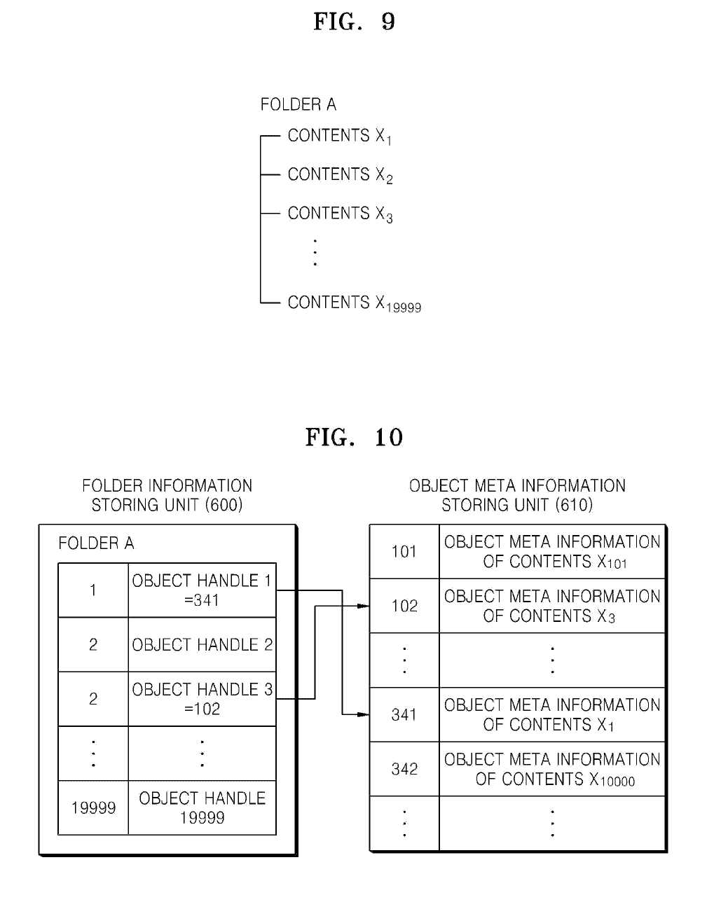

FIG. 9 is a conceptual view illustrating a case where contents are stored in a folder in an apparatus for storing and processing contents. FIG. 10 illustrates a case where object meta information on contents is stored in an apparatus for storing and processing contents through object meta handles. Referring to FIGS. 9 and 10, it is recognized that the contents are included in the folder A. However, object handles related to contents corresponding to the folder A are stored in a folder information storing unit 600 including information on a practical folder. An object handle is data including information on a position where object meta information is stored in an object meta information storing unit 610 for storing object meta information. For example, in FIG. 10, pieces of object meta information on contents 1 to 3 are stored in an address of 341 and an address of 102, respectively, of the object meta information storing unit 610. At this time, an object handle on the content 1 has a value 341 and an object handle on the content 3 has a value 102.

The folder information storing unit 600 is independent of the object meta information storing unit 610 since it is difficult to manage the folder information storing unit 600 in a case where the object meta information is directly stored in the folder A. This is similar to an operating system (OS) that has an address table for managing data independently of a space for storing the data. However, it is understood that such units 600, 610 can be combined in other aspects of the present invention.

In a conventional MTP technique, when a user selects the folder A in the content reproduction apparatus and requests the apparatus for storing and processing contents to provide information on the folder A, values of all the object handles (object handles 1 to 19999 in an example of FIG. 10) included in the folder A are transmitted to the content reproduction apparatus. If the folder A includes 100,000 contents, 100,000 object handles are transmitted from the apparatus for storing and processing contents to the content reproduction apparatus. Accordingly, as described above, a transmission delay occurs, thereby causing an inconvenience to the user.

In aspects of the present invention, however, a limited number of pieces of object meta information is selected and transmitted by recognizing and using a fact that the object handle and object meta information are separately stored in the apparatus for storing and processing contents. In order to embody the method, information on a position of the last transmitted piece of object meta information among recently transmitted pieces of object meta information is stored in the first storage unit 330 or 530.

Several non-limiting examples of methods of selecting object meta information will now be described with reference to FIGS. 11 and 12. FIG. 11 illustrates a procedure of selecting object meta information according to an embodiment of the present invention. In FIG. 11, a method of selecting pieces of object meta information that are stored in an object meta information storing unit 610 is shown.

Referring to FIG. 11, a limited number of object handles corresponding to a folder A are selected in the folder information storing unit 600 in operation S700. Specifically, operation S700 is performed by the object handle selection unit when included in the apparatus 300 illustrated in FIG. 6. A limited number of pieces of object meta information are extracted from the object meta information storing unit 610 by using the selected object handles in operation S710. Specifically, operation S710 is performed by the object meta information extraction unit when included in the apparatus 300 illustrated in FIG. 6.

The object meta information selection unit 320 stores an address where the last object handle is stored as information on a position of the last transmitted piece of object meta information in the first storage unit 330 in operation S720. If the content reproduction apparatus requests next pieces of object meta information, the address value stored in the first storage unit 330 is read, and a limited number of object handles are selected from the next positions in operation S730. The object meta information extraction unit extracts a limited number of pieces of object meta information by using the selected object handles in operation S740. In addition, an address where the last object handle is stored is stored in the first storage unit 300 (operation S750).

FIG. 12 illustrates a procedure of selecting object meta information according to another embodiment of the present invention. Like the embodiment illustrated in FIG. 8, FIG. 12 illustrates a case where the sorting standard receiving unit 560, the object meta information table 570, and the object meta information sorting unit 580 are further included in the apparatus for storing and processing contents 500. Referring to FIG. 12, when a message indicating that a folder A is selected by a user is received from the content reproduction apparatus (for example, operation S210 of FIG. 4), pieces of object meta information on all the contents included in the folder A are extracted from among pieces of object meta information stored in the object meta information storing unit 610 and stored in the object meta information table 570 in operation S800. Since the object meta information is extracted and stored in the apparatus 500 for storing and processing contents, it is possible to rapidly perform the extraction and storing (operation S800) without a delay.

When a property of a display standard of the content reproduction apparatus is changed, the content reproduction apparatus transmits the changed property to the apparatus 500 for storing and processing contents. The sorting standard receiving unit 560 receives the changed property as the sorting standard of the object meta information. For example, such a changed property may occur when the user initially displays content information based on content names and then changes settings so as to display content information based on content sizes. The sorting standard receiving unit 560 stores the received sorting standard in a sorting standard storing unit 620, and the object meta information sorting unit 580 sorts pieces of object meta information stored in the object meta information table 570 according to the sorting standard in operation S810.

When a message requesting object meta information is received from the content reproduction apparatus, the object meta information selection unit 520 selects a limited number of pieces of object meta information from among the sorted pieces of object meta information, transmits the selected pieces of object meta information in operation S820, and stores a position of the last transmitted piece of object meta information in the first storage unit 530 in operation S830.

Next, when a message requesting object meta information is received, a limited number of pieces of object meta information are selected from a next position to the position stored in the first storage unit 530 and transmitted in operation S840. A position of the last piece of the selected pieces of object meta information is stored in the first storage unit 530.

Unlike the example illustrated in FIG. 11, in the example of FIG. 12, object meta information is directly selected from the object meta information table 570 and transmitted. Object handles are used only in the extracting of pieces of object meta information from the object meta information storing unit 610 in operation S800. Object handles are not used in subsequent procedures (operations S820 and S840) of selecting object meta information.

In order to perform the method illustrated in FIG. 12, the apparatus 500 for storing and processing contents may include a processor capable of sorting data. Since the apparatus 500 for storing and processing contents according to an embodiment of the present invention can process data of an MP3 player or PMP, the apparatus 500 for storing processing contents includes the aforementioned capability of processing data. In addition, it is possible to perform functions of the object meta information table 570, the sorting standard storing unit 620, the object meta information sorting unit 580, and the like by using a database (DB), but the invention is not limited thereto.

According to aspects of the present invention, since only a limited number of pieces of object meta information are selected according to a display status of a content reproduction apparatus, and only the selected pieces of object meta information are transmitted to the content reproduction apparatus, it is possible to minimize an MTP operation for transmitting the object meta information and to minimize a transmission of data. As a result, an inconvenience to a user and a latency time of an operation are reduced by reducing a delay time in a connection between devices.

Aspects of the present invention can also be embodied as computer-readable codes on a computer-readable recording medium and implemented using one or more computers and/or processors. The computer-readable recording medium is any data storage device that can store data that can thereafter be read by a computer system. Examples of the computer-readable recording medium include read-only memory (ROM), random-access memory (RAM), CD-ROMs, magnetic tapes, floppy disks, and optical data storage devices. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of transmitting object meta information on contents from an apparatus for storing and processing the contents to a content reproduction apparatus through a media transfer protocol (MTP), the method comprising:
receiving from the content reproduction apparatus information on a folder including the contents corresponding to the object meta information to be transmitted;
selecting a limited number of pieces of object meta information from among all pieces of object meta information on the contents included in the folder according to a display status of the content reproduction apparatus;
storing information on a position of a last selected piece of object meta information among the selected pieces of object meta information in a first storage unit; and
transmitting the selected pieces of object meta information to the content reproduction apparatus.

2. The method as claimed in claim 1, wherein the selecting of the limited number of pieces of object meta information comprises:
selecting the limited number of pieces of object meta information counting from object meta information on a first content among contents included in the folder when initially transmitting object meta information on the folder; and
selecting the limited number of pieces of object meta information counting from object meta information on next contents to contents corresponding to previously transmitted object meta information by using the information on the position of the last selected piece of object meta information stored in the first storage unit when additionally transmitting object meta information on the folder.

3. The method as claimed in claim 1, wherein the receiving of the information on the folder includes receiving, from the content reproduction apparatus, information on the display status of the content reproduction apparatus with the information on the folder.

4. The method as claimed in claim 3, wherein the selecting the limited number of pieces of object meta information comprises:
storing the received information on the display status of the content reproduction apparatus in a second storage unit; and
selecting the limited number of pieces of object meta information using the stored information on the display status stored in the second storage unit.

5. The method as claimed in claim 4, wherein the second storage unit is distinct from the first storage unit.

6. The method as claimed in claim 4, further comprising:
receiving, from the content reproduction apparatus, information indicating that the display status of the content reproduction apparatus is changed; and
storing the information on the changed display status in the second storage unit.

7. The method as claimed in claim 3, wherein the selecting the limited number of pieces of object meta information comprises:
selecting a limited number of object handles corresponding to the contents included in the folder according to the display status; and
extracting the limited number of pieces of object meta information according to the display status using the selected object handles.

8. The method as claimed in claim 7, wherein:
the storing of the information on the position of the last selected piece of object meta information includes storing in the first storage unit a position in which an object handle that is finally selected from among the selected object handles is stored; and
the selecting of the limited number of object handles includes selecting the limited number of object handles counting from a next position to the position of the object handle that is finally selected stored in the first storage unit.

9. The method as claimed in claim 3, wherein the information on the display status of the content reproduction apparatus indicates a number of pieces of object meta information that can be concurrently displayed by the content reproduction apparatus.

10. The method as claimed in claim 1, further comprising:
receiving, from the content reproduction apparatus, a sorting standard of pieces of object meta information to be transmitted;
extracting the pieces of object meta information on all of the contents included in the folder; and
sorting the extracted pieces of object meta information according to the received sorting standard,
wherein the selecting of the limited number of pieces of object meta information includes selecting the limited number of pieces of object meta information from among the sorted pieces of object meta information.

11. The method as claimed in claim 1, wherein the object meta information includes information on copyrights of respective contents corresponding to the object meta information.

12. The method as claimed in claim 1, wherein:
the selecting of the limited number of pieces of object meta information comprises:
receiving, from the content reproduction apparatus, a message for requesting a first number of pieces of object meta information,
extracting object handles corresponding to the first number of pieces of object meta information from among the pieces of object meta information on the contents included in the folder, and
selecting the first number of pieces of object meta information from among the pieces of object meta information on the contents included in the folder using the extracted object handles; and
the storing of the information on the position of the last selected piece of object meta information comprises storing in the first storage unit a position where an object handle corresponding to the last piece of object meta information of the extracted object handles is stored.

13. The method as claimed in claim 1, wherein the display status of the content reproduction apparatus indicates a number of pieces of object meta information that can be concurrently displayed by the content reproduction apparatus.

14. The method as claimed in claim 1, wherein the apparatus for storing and processing the contents is a portable multimedia player and the content reproduction apparatus is a personal computer.

15. The method as claimed in claim 1, wherein the apparatus for storing and processing the contents and the content reproduction apparatus are connected through WINDOWS media player and/or file explorer, and the display status of the content reproduction apparatus indicates a number of pieces of object meta information that can be concurrently displayed on the WINDOWS media player and/or the file explorer.

16. An apparatus for storing and processing contents, and to transmit object meta information on the contents to a content reproduction apparatus through a media transfer protocol (MTP), the apparatus comprising:
a folder information receiving unit to receive, from the content reproduction apparatus, information on a folder including the contents corresponding to the object meta information to be transmitted to the content reproduction apparatus;
an object meta information selection unit to select a limited number of pieces of object meta information from among all pieces of object meta information on the contents included in the folder according to a display status of the content reproduction apparatus;
a first storage unit to store information on a position of a last selected piece of object meta information among the selected pieces of object meta information; and
an object meta information transmission unit to transmit the selected pieces of object meta information to the content reproduction apparatus.

17. The apparatus as claimed in claim 16, wherein:
the object meta information selection unit selects the limited number of pieces of object meta information counting from object meta information on a first content among contents included in the folder when initially transmitting object meta information with respect to the folder; and
the object meta information selection unit selects the limited number of pieces of object meta information counting from object meta information on next contents to contents corresponding to previously transmitted object meta information using the stored information on the position of the last selected piece of object meta information stored in the first storage unit when additionally transmitting object meta information on the folder.

18. The apparatus as claimed in claim 16, further comprising a second storage unit to store information on the display status of the content reproduction apparatus, wherein:
the folder information receiving unit receives, from the content reproduction apparatus, the information on the display status of the content reproduction apparatus with the information on the folder and stores the received information in the second storage unit; and
the object meta information selection unit selects the limited number of pieces of object meta information using the stored information on the display status stored in the second storage unit.

19. The apparatus as claimed in claim 18, wherein the object meta information selection unit comprises:
an object handle selection unit to select a limited number of object handles corresponding to the contents included in the folder according to the display status; and
an object meta information extraction unit to extract the limited number of pieces of object meta information according to the display status using the selected object handles.

20. The apparatus as claimed in claim 19, wherein the object handle selection unit:
stores, in the first storage unit, a position where an object handle that is finally selected from among the selected object handles is stored; and
selects the limited number of object handles counting from a next position to the position of the object handle that is finally selected stored in the first storage unit.

21. The apparatus as claimed in claim 18, wherein the information on the display status of the content reproduction apparatus indicates a number of pieces of object meta information that can be concurrently displayed by the content reproduction apparatus.

22. The apparatus as claimed in claim 16, further comprising:
a sorting standard receiving unit to receive, from the content reproduction apparatus, a sorting standard of pieces of object meta information to be transmitted;
an object meta information table to extract and to store the pieces of object meta information on all of the contents included in the folder; and
an object meta information sorting unit to sort the extracted pieces of object meta information stored in the object meta information table according to the received sorting standard,
wherein the object meta information selection unit selects the limited number of pieces of object meta information from among the sorted pieces of object meta information.

23. The apparatus as claimed in claim 16, wherein the object meta information includes information on copyrights of respective contents corresponding to the object meta information.

24. The apparatus as claimed in claim 16, wherein, when receiving a message for requesting a first number of pieces of object meta information from the content reproduction apparatus, the object meta information selection unit extracts object handles corresponding to the first number of pieces of object meta information from among the pieces of object meta information on the contents included in the folder, selects the first number of pieces of object meta information from among the pieces of object meta information on the contents included in the folder using the extracted object handles, and stores in the first storage unit a position where an object handle corresponding to a last piece of object meta information of the extracted object handles is stored.

25. The apparatus as claimed in claim 16, wherein the display status of the content reproduction apparatus indicates a number of pieces of object meta information that can be concurrently displayed by the content reproduction apparatus.

26. The apparatus as claimed in claim 16, wherein the apparatus for storing and processing the contents is a portable multimedia player and the content reproduction apparatus is a personal computer.

27. The apparatus as claimed in claim 16, wherein the object meta information transmission unit transmits the selected pieces of object meta information to WINDOWS media player and/or file explorer of the content reproduction apparatus, and the display status of the content reproduction apparatus indicates a number of pieces of object meta information that can be concurrently displayed on the WINDOWS media player and/or the file explorer.

28. A method of transmitting object meta information on contents from an apparatus for storing and processing the contents to a content reproduction apparatus through a media transfer protocol (MTP), the method comprising:
selecting a limited number of pieces of the object meta information from among all pieces of the object meta information on contents included in a predetermined folder according to a display status of the content reproduction apparatus; and
transmitting the selected pieces of object meta information to the content reproduction apparatus.

29. The method as claimed in claim 28, further comprising storing information on a position of a last selected piece of the object meta information from among the selected pieces of object meta information in a first storage unit.

30. The method as claimed in claim 28, wherein the display status of the content reproduction apparatus indicates a number of pieces of object meta information that can be concurrently displayed by the content reproduction apparatus.

31. A system to transmit object meta information on contents through a media transfer protocol (MTP), the system comprising:
an apparatus to store and process the contents comprising:
an object meta information selection unit to select a limited number of pieces of object meta information from among all pieces of object meta information on the contents included in a predetermined folder according to a received display status, and
an object meta information transmission unit to transmit the selected pieces of object meta information; and
a content reproduction apparatus comprising:
a receiving unit to receive the limited number of pieces of object meta information,
a display unit to display the received pieces of object meta information, and
a transmission unit to transmit the display status of the display unit to the apparatus to store and process the contents.

32. The system as claimed in claim 31, wherein the apparatus to store and process the contents comprises a folder information receiving unit to receive, from the content reproduction apparatus, information on the predetermined folder including the contents corresponding to the object meta information to be transmitted to the content reproduction apparatus;

33. The system as claimed in claim 31, wherein the apparatus to store and process the contents comprises a first storage unit to store information on a position of a last selected piece of object meta information among the selected pieces of object meta information.

34. The system as claimed in claim 31, wherein the display status of the display unit of the content reproduction apparatus indicates a number of pieces of object meta information that can be concurrently displayed by the content reproduction apparatus.

35. A content reproduction apparatus to receive object meta information on contents through a media transfer protocol (MTP), the apparatus comprising:
a receiving unit to receive a limited number of pieces of object meta information from an apparatus to store and process the contents that determines the limited number of pieces of object meta information to be transmitted according to a display status received from the content reproduction apparatus; and
a display unit to display the received pieces of object meta information.

36. The apparatus as claimed in claim 35, further comprising:
a transmission unit to transmit the display status of the display unit to the apparatus to store and process the contents.

37. The apparatus as claimed in claim 36, wherein the transmission unit transmits, to the apparatus to store and process the contents, information on a folder including the contents corresponding to the object meta information to be received.

38. The apparatus as claimed in claim 35, wherein the display status indicates a number of pieces of object meta information that can be concurrently displayed by the display unit.

39. A method of receiving, at a content reproduction apparatus from an apparatus for storing and processing contents, object meta information on contents through a media transfer protocol (MTP), the method comprising:
receiving a limited number of pieces of object meta information from the apparatus to store and process the contents that determines the limited number of pieces of object meta information according to a received display status of the content reproduction apparatus; and
displaying the received pieces of object meta information.

40. The method as claimed in claim 39, further comprising:
transmitting the display status of the content reproduction apparatus to the apparatus for storing and processing contents.

41. The method as claimed in claim 39, wherein the display status of the content reproduction apparatus indicates a number of pieces of object meta information that can be concurrently displayed by the content reproduction apparatus.

42. A computer-readable recording medium having embodied thereon a computer program for executing the method of transmitting object meta information on contents from an apparatus for storing and processing the contents to a content reproduction apparatus through a media transfer protocol (MTP) of claim 1 and implemented using on ore more processors.

43. A computer-readable recording medium having embodied thereon a computer program for executing the method of transmitting object meta information on contents from an apparatus for storing and processing the contents to a content reproduction apparatus through a media transfer protocol (MTP) of claim 28 and implemented using on ore more processors.

44. A computer-readable recording medium having embodied thereon a computer program for executing the method of receiving, at a content reproduction apparatus from an apparatus for storing and processing contents, object meta information on contents through a media transfer protocol (MTP) of claim 39 and implemented using on ore more processors.
